(19) United States
(12) Patent Application Publication
(10) Pub. No.: US 2018/0079235 A1
(43) Pub. Date: Mar. 22, 2018

(54) METHOD AND SYSTEM TO CALCULATE LINE FEED ERROR IN LABELS ON A PRINTER

(71) Applicant: Datamax-O'Neil Corporation, Orlando, FL (US)

(72) Inventors: Ramanathan Alaganchetty, Singapore (SG); Rajan Narayanaswami, Singapore (SG)

(21) Appl. No.: 15/642,609

(22) Filed: Jul. 6, 2017

Related U.S. Application Data
(63) Continuation of application No. 15/270,378, filed on Sep. 20, 2016, now Pat. No. 9,701,140.

(51) Int. Cl. B41J 13/00; B41J 2/32

(52) U.S. Cl. CPC B41J 13/0009; B41J 2/32

(57) ABSTRACT

A system to calculate line feed error in labels on a printer includes a holder assembly under the label line feed and before the printer burn line; a first sensor and a second sensor on the holder assembly, a fixed distance, L, between them; and a processor. The first sensor senses a first position of a label edge, L1A. The second sensor senses a second position of the label edge, L1B. The processor calculates the distance, L1AB, between the first position and the second position and calculates the line feed error over the fixed distance, L, by taking the difference (L−L1AB). The processor calculates the feed correction to be done to the label, given by [(L−L1AB)/L]×D, where D is a distance between the first sensor and the burn line of the printer. The processor instructs the printer line feed to implement the calculated feed correction.

### CROSS-REFERENCE TO RELATED APPLICATION

The present application claims the benefit of U.S. patent application Ser. No. 15/270,378 for a Method and System to Calculate Line Feed Error in Labels on a Printer filed Sep. 20, 2016, now U.S. Pat. No. 9,701,140. Each of the foregoing patent application and patent is hereby incorporated by reference in its entirety.

### FIELD OF THE INVENTION

The present invention relates to label printers and in particular to methods and systems of determining line feed errors and correcting line feed errors.

### BACKGROUND

Generally speaking instantaneous feed error between the Label Stop Sensor (LSS) and the Thermal Print Head's (TPH) burn line always varies depending upon the type of label, forces acting upon label and ambient conditions. The LSS is a positional sensor, identifying the edge or gap or black mark of the label.

Without instantaneous feed error correction the quality of the print registration would be challenged. Print registration is the accuracy of the position of the printed image on the label and effects print quality.

There are systems known in the art for determining label positions. For example US Publication 20130244872A1 discloses a thermal printer with an optical registration system especially for use with labels having fluorescent stripe patterns. However, no line feed correction calculation is provided for. Likewise, U.S. Pat. No. 8,029,083 discloses a label printer to determine the position of a label. However, the '083 reference makes no provision for the determination and correction of line feed error for the label.

Therefore, a need exists for a system and method of determining the position of labels on the line feed of a label printer, determining the line feed error of the label, and correcting the line feed error before the burn line on the label printer.

### SUMMARY

Accordingly, the present invention embraces a method of calculating line feed error of at least one label on a printer.

In an exemplary embodiment, the method comprises the steps of: a) providing a first sensor and a second sensor on a holder assembly with a fixed distance, L, between the first sensor and the second sensor; b) feeding the label over the first and second sensors on the holder assembly; c) sensing a position of a first edge of the label, L1A, by the first sensor as the label moves over the first sensor; d) sensing a second position of the first edge of the label, L1B, by the second sensor as the label moves over the second sensor; e) calculating the distance, L1AB, between the first position and the second position; f) calculating the line feed error over the fixed distance, L, by taking the difference (L−L1AB); and g) calculating the feed correction to be done to the label, where the feed correction is given by [(L−L1AB)/L]×D, where D is a distance between the first sensor and the burn line of the printer.

In another exemplary embodiment, the method further comprises the step of h) correcting the line feed based upon the step (f) of calculating the feed correction.

In another exemplary embodiment of the method, the at least one label is every label fed over the first and second sensors.

In another exemplary embodiment of the method, the steps a-h are repeated for every label fed over the first and second sensors.

In yet another exemplary embodiment of the method, the calculating steps e-g and the correcting step are accomplished with a processor.

In another exemplary embodiment of the method, the fixed distance L has a tolerance of about +/−20 microns; that is, the fixed distance is from about L−20 microns to about L+20 microns.

In another exemplary embodiment of the method, the first edge is selected from a leading edge of the label and the trailing edge of the label as the label passes over the holder assembly.

In another aspect, the present invention embraces a method of calculating line feed error in at least one label having an optical feature on a printer.

In an exemplary embodiment, the method comprises the steps of: a) providing a first sensor and a second sensor on a holder assembly with a fixed distance, L, between the first sensor and the second sensor; b) feeding the label over the first and second sensors on the holder assembly; c) sensing a position of the optical feature of the label, L1A, by the first sensor as the label moves over the first sensor; d) sensing a second position of the optical feature label, L1B, by the second sensor as the label moves over the second sensor; e) calculating the distance, L1AB, between the first position and the second position; f) calculating the line feed error over the fixed distance, L, by taking the difference (L−L1AB); and g) calculating the feed correction to be done to the label, where the feed correction is given by [(L−L1AB)/L]×D, where D is a distance between the first sensor and the burn line of the printer.

In another exemplary embodiment of the method, the optical feature is a differential opacity of media between an edge of the label and a carrier media.

In another exemplary embodiment of the method, the edge of the label is the leading edge of the label or the trailing edge of the label.

In another exemplary embodiment of the method, the optical feature is a luminescent mark on the label.

In another exemplary embodiment, the method further comprises the step of h) correcting the line feed based upon the step (g) of calculating the feed correction.

In yet another exemplary embodiment of the method, the at least one label is every label fed over the first and second sensors.

In another exemplary embodiment of the method, the steps a-h are repeated for every label fed over the first and second sensors.

In another exemplary embodiment of the method, the fixed distance L, has a tolerance of about +/−20 microns.

In yet another exemplary embodiment of the method, the optical feature is a fluorescent stripe. The fluorescent stripe is disposed at a predetermined position on the label and at the same predetermined position on every label fed over the first and second sensors.

In another aspect, the present invention embraces a system to calculate line feed error in labels on a printer.

In an exemplary embodiment, the system is comprised of: a holder assembly positioned in the printer under the label line feed and before the printer burn line; a first sensor and a second sensor disposed on the holder assembly with a fixed distance, L, between the first sensor and the second sensor; and a processor communicatively linked to the first sensor and the second sensor and to the printer line feed. The first sensor is configured to sense a first position of a first edge of the label, L1A, as the label moves over the first sensor. The second sensor is configured to sense a second position of the first edge of the label, L1B, as the label moves over the second sensor. The processor is configured to calculate the distance, L1AB, between the first position and the second position. The processor is further configured to calculate the line feed error over the fixed distance, L, by taking the difference (L−L1AB). The processor is further configured to calculate the feed correction to be done to the label, where the feed correction is given by [(L−L1AB)/L]×D, and where D is a distance between the first sensor and the burn line of the printer. The processor is yet further configured to instruct the printer line feed to implement the calculated feed correction.

In another exemplary embodiment of the system, the first edge is provided with an optical feature. The first and second sensors are optical sensors sensitive to the optical feature.

In another exemplary embodiment of the system, the optical feature is a differential in opacity of the media.

In another exemplary embodiment of the system, the fixed distance L has a tolerance of about +/−20 microns.

In another exemplary embodiment of the system, the first edge of the label is selected from the leading edge of the label and the trailing edge of the label.

In another aspect, the present invention embraces a system to calculate line feed error on a printer.

In an exemplary embodiment, the system is comprised of: a holder assembly positioned in the printer before a printer burn line, a first sensor and a second sensor disposed on the holder assembly with a fixed distance, L, between the first sensor and the second sensor, and a processor communicatively linked to the first sensor and the second sensor. The first sensor is configured to sense a first position of a first edge of the label, L1A, as the label moves over the first sensor. The second sensor is configured to sense a second position of the first edge of the label, L1B, as the label moves over the second sensor. The processor is configured to calculate a distance, L1AB, between the first position and the second position. The processor is further configured to calculate a line feed error over the fixed distance, L, by taking the difference (L−L1AB).

In another exemplary embodiment of the system, the processor is further configured to calculate the feed correction to be done to the label, where the feed correction is given by [(L−L1AB)/L]×D, where D is a distance between the first sensor and the printer burn line.

In another exemplary embodiment of the system, the first edge is provided with an optical feature.

In another exemplary embodiment of the system, the optical feature is at least one of a differential in transmissivity of the media or a differential in reflectance of the media.

In another exemplary embodiment of the system, the fixed distance L has a tolerance of about +/−20 microns.

In yet another exemplary embodiment of the system, the first edge of the label is selected from the leading edge of the label and the trailing edge of the label.

In another aspect, the invention embraces a method of calculating line feed error on a printer comprising the steps of: a) providing a first sensor and a second sensor on a holder assembly with a fixed distance, L, between the first sensor and the second sensor; b) feeding a label near the first and second sensors on the holder assembly; c) sensing a position of a first edge of the label, L1A, by the first sensor as the label moves near the first sensor; d) sensing a second position of the first edge of the label, L1B, by the second sensor as the label moves near the second sensor; e) calculating the distance, L1AB, between the first position and the second position; f) calculating the line feed error over the fixed distance, L, by taking the difference (L−L1AB); and g) calculating the feed correction to be done to the label, where the feed correction is given by [(L−L1AB)/L]×D, where D is a distance between the first sensor and a burn line of the printer.

In another exemplary embodiment, the method further comprises the step of: h) correcting the line feed based upon the step g) of calculating the feed correction.

In another exemplary embodiment of the method, the calculating steps e-g and the correcting step are accomplished with a processor.

In another exemplary embodiment of the method, the fixed distance L has a tolerance of about +/−20 microns.

In yet another exemplary embodiment of the method, the first edge is selected from a leading edge of the label and the trailing edge of the label as the label passes near the holder assembly.

In another aspect, the invention embraces another method of calculating line feed error on a printer comprising the steps of: a) providing a first sensor and a second sensor on a holder assembly with a fixed distance, L, between the first sensor and the second sensor; b) feeding a label having an optical feature near the first and second sensors on the holder assembly; c) sensing a position of the optical feature, L1A, by the first sensor as the label moves near the first sensor; d) sensing a second position of the optical feature, L1B, by the second sensor as the label moves near the second sensor; e) calculating a distance, L1AB, between the first position and the second position; f) calculating a line feed error over the fixed distance, L, by taking the difference (L−L1AB); and g) calculating a feed correction to be done to the label, where the feed correction is given by [(L−L1AB)/L]×D, where D is a distance between the first sensor and the burn line of the printer.

In another exemplary embodiment of the method, the optical feature is at least one of a differential transmissivity or a differential in reflectance between an edge of the label and a carrier media.

In another exemplary embodiment, the method further comprises the step of h) correcting the line feed based upon the step g) of calculating the feed correction.

In another exemplary embodiment of the method, the fixed distance L has a tolerance of about +/−20 microns.

In another exemplary embodiment of the method, the edge of the label is selected from the leading edge and the trailing edge of the label.

In yet another exemplary embodiment of the method, the optical feature is a fluorescent stripe. The fluorescent stripe is disposed at a predetermined position on the label and at the same predetermined position on every label fed near the first and second sensors.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 schematically depicts the hardware portion of a system for calculating line feed error in labels on a printer in accordance with an exemplary embodiment of the present invention.

FIG. 2 schematically depicts a portion of a string of typical labels on a carrier media which could be used in conjunction with exemplary embodiments of the present invention.

FIG. 3 schematically depicts in a flowchart the functions of the hardware portion of the system for calculating line feed error in labels on a printer in accordance with an exemplary embodiment of the present invention depicted in FIG. 1.

FIG. 4 schematically depicts in a flowchart a method for calculating line feed error of at least one label on a printer in accordance with one exemplary embodiment of the present invention.

FIG. 5 schematically depicts in a flowchart another method for calculating line feed error of at least one label with an optical feature on a printer in accordance with another exemplary embodiment of the present invention.

### DETAILED DESCRIPTION

The present invention embraces a system to calculate line feed error in labels on a printer.

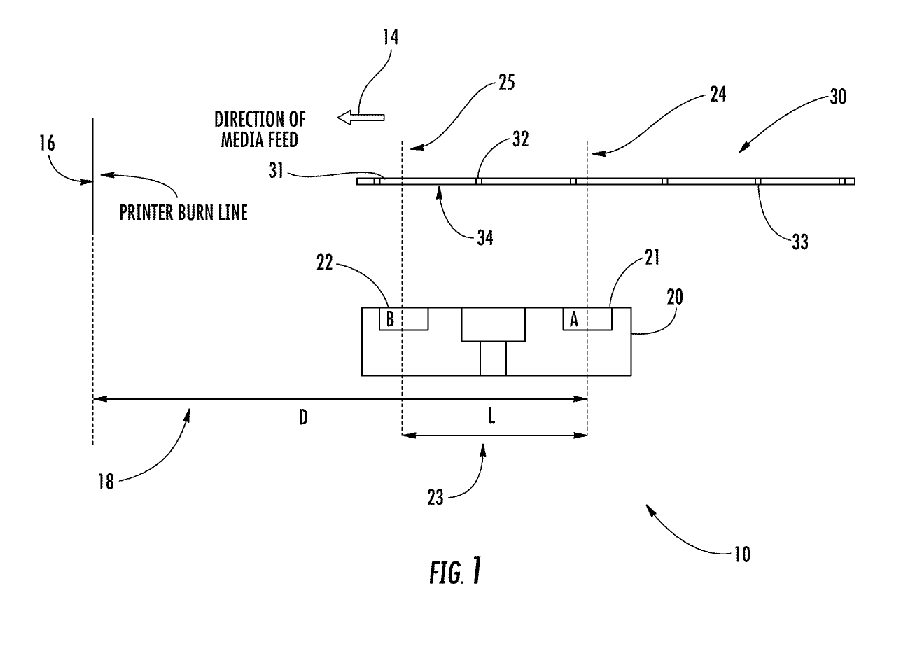

In an exemplary embodiment, referring to FIG. 1, the system (10) is comprised of a holder assembly (20), with a first sensor, designated A (21), and a second sensor, designated B (22), disposed within the holder assembly (20) at a fixed distance, L (23) from each other. The fixed distance L preferably has a tolerance of +/−20 microns.

The holder assembly (20) is positioned in the printer under the feed line (14) where the label media (30) passes over the first sensor A (21) and the second sensor B (22) as the label media (30) progresses towards the burn line (16). The burn line (16) is a distance D (18) from the first sensor.

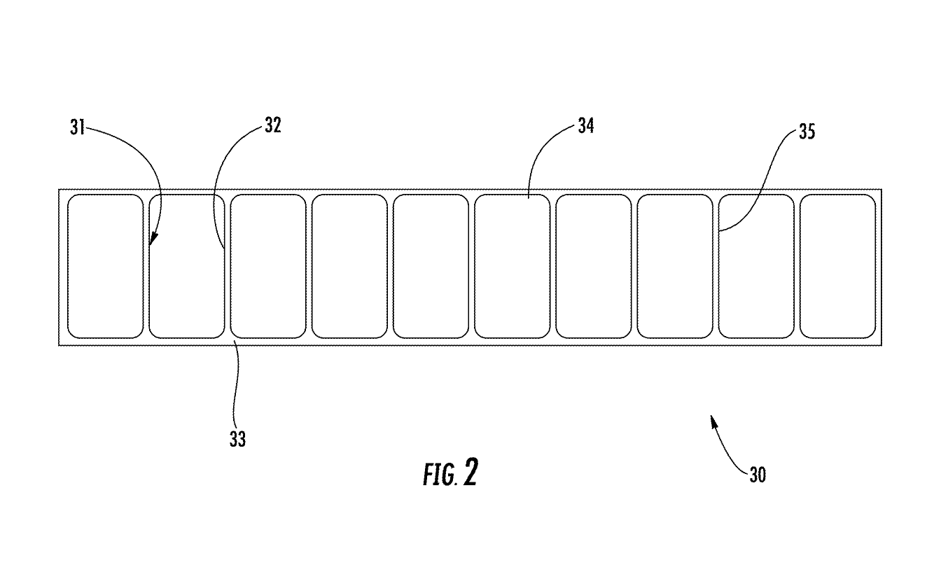

The label media (30), which can be seen in more detail in FIG. 2, is comprised of a carrier (33) and labels (34). Each label (34) has a leading edge (31) and a trailing edge (32). Generally, there is a difference in opacity between the carrier (33) and the labels (34).

Referring again to FIG. 1, the first sensor A (21) senses a first position (24) of an optical feature of a label (34) passing over the first sensor A (21). The second sensor B (22) senses a second position (25) of the same optical feature of the label (34) as the label (34) passes over the second sensor B (22). The optical feature may be the difference in opacity of the label (34) and the carrier (33). Thus the particular optical feature sensed by the first sensor A (21) at the first position (24) is either the leading edge (31) or the trailing edge (32) of the label (34). Accordingly, the same leading edge (31) or trailing edge (32) is sensed by the second sensor B (22) at the second position (25).

In another exemplary embodiment, as shown in FIG. 2, the optical feature may be a fluorescent stripe (35).

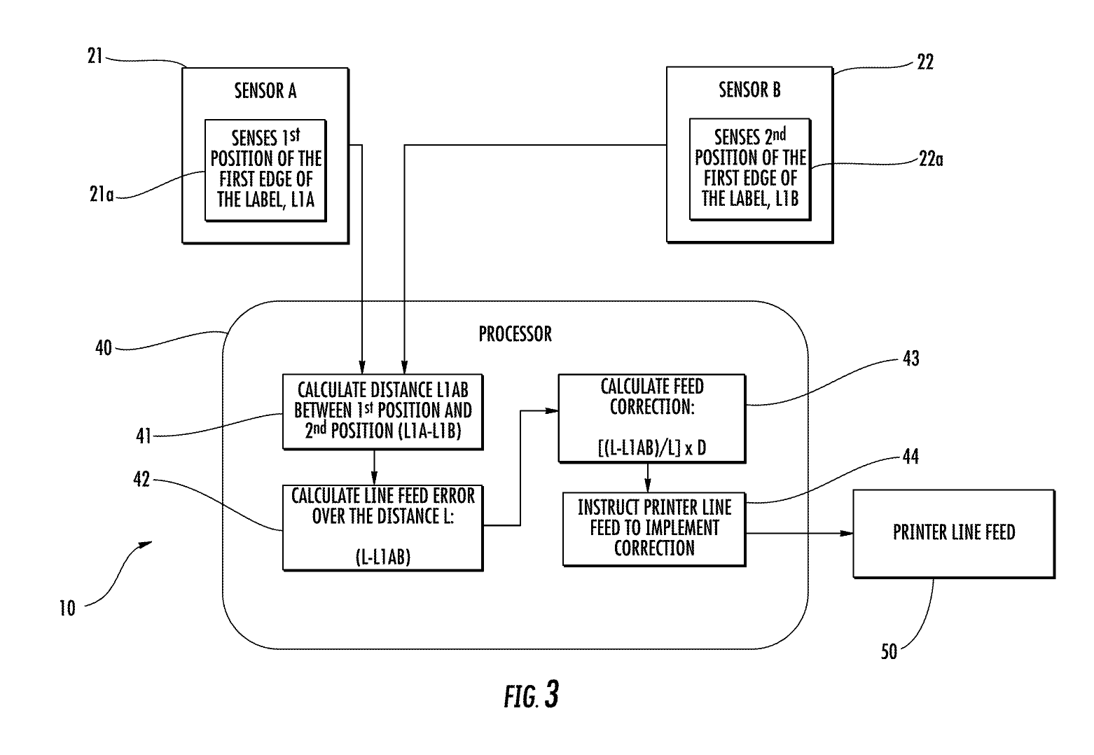

Referring now to FIG. 3, the system (10), whose hardware is depicted in the previous figures, has system functions which are depicted in the instant Figure. Sensor A (21) senses a first position of an optical feature of a label, the function and sensed data being designated (21a). In the present case, the optical feature is the first edge of the label. The second sensor B (22) senses a second position of the first edge of the label. This function and sensed data is designated (22a). The Sensor A (21) and Sensor B (22) are communicatively linked to a Processor (40). The communicative links are shown as arrows between the sensors (21 and 22) and the processor (40). The processor (40) receives the sensed data (21a and 22a) from the sensors (21 and 22). The processor (40) is configured to (41) calculate the distance, L1AB, between the first position and the second position. The processor (40) is further configured to (42) calculate the line feed error over the fixed distance, L, by taking the difference (L−L1AB). The processor (40) is yet further configured to (43) calculate the feed correction to be done to the label, where the feed correction is given by [(L−L1AB)/L]×D, where D is a distance between the first sensor and the burn line of the printer. Finally, the processor is configured to (44) instruct the printer line feed (50) to implement the calculated feed correction (43).

In another aspect, the present invention embraces a method of calculating line feed error of at least one label on a printer. The method of the hereinafter exemplary embodiment may advantageously employ the hardware and software function described hereinbefore in conjunction with FIGS. 1-3.

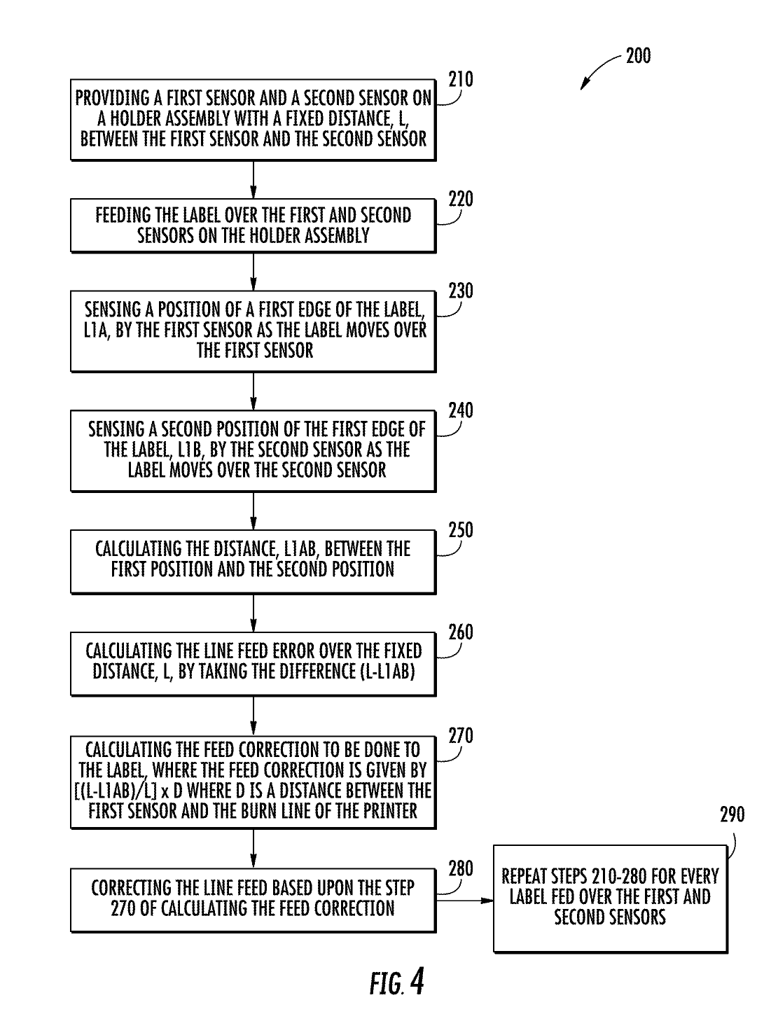

Referring now to FIG. 4, in an exemplary embodiment, the method (200) is comprised of steps: (210) providing a first sensor and a second sensor on a holder assembly with a fixed distance, L, between the first sensor and the second sensor; (220) feeding the label over the first and second sensors on the holder assembly; (230) sensing a position of the optical feature of the label, L1A, by the first sensor as the label moves over or near the first sensor; (240) sensing a second position of the optical feature label, L1B, by the second sensor as the label moves over or near the second sensor; (250) calculating the distance, L1AB, between the first position and the second position; (260) calculating the line feed error over the fixed distance, L, by taking the difference (L−L1AB); and (270) calculating the feed correction to be done to the label, where the feed correction is given by [(L−L1AB)/L]×D, where D is a distance between the first sensor and the burn line of the printer.

In another exemplary embodiment, the method (200) further includes the step of: (280) correcting the line feed based upon the step (270) of calculating the feed correction.

In another exemplary embodiment, the method (200) further includes the step of repeating steps (210-280) for every label fed over the first and second sensors.

In the method (200) the at least one label is every label fed over or near the first and second sensors. Thus the method is used continuously and repeatedly for every label feed through the printer.

In the method (200) the calculating steps (250-270) are accomplished with a processor as described hereinbefore with respect to the system.

In the method (200), the fixed distance, L, has a tolerance of about +/−20 microns.

In the method (200), the first edge may be the leading edge of the label as the label passes over or near the holder assembly. Alternatively, the first edge may be the trailing edge of the label as the label passes over or near the holder assembly.

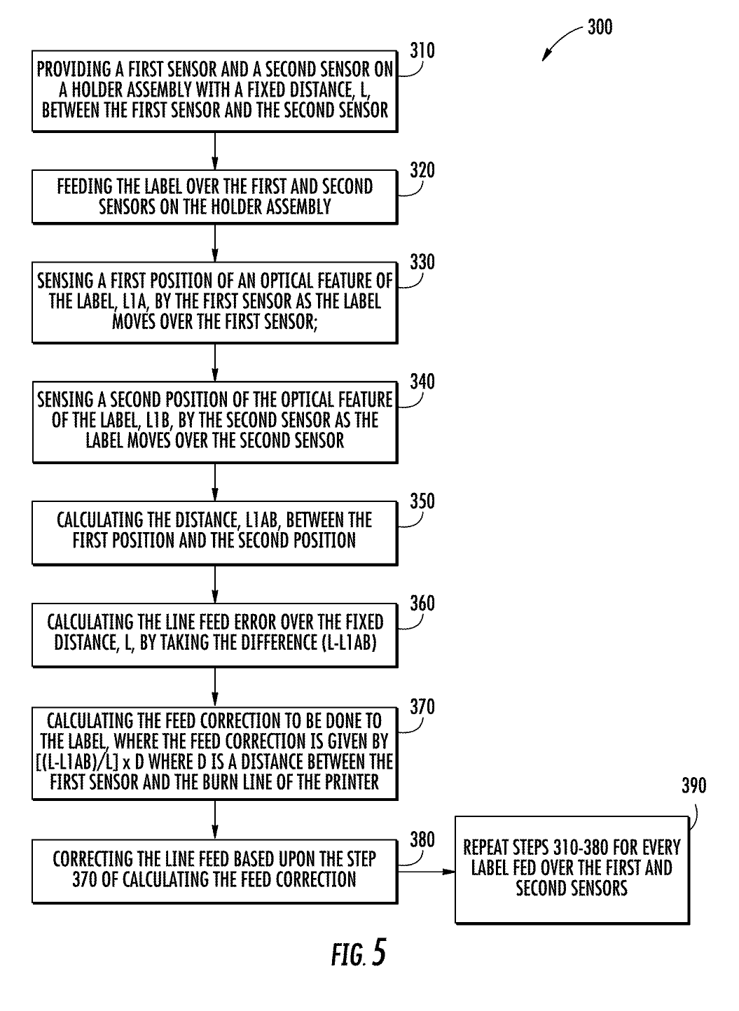

In another exemplary embodiment, referring now to FIG. 5, a method (300) of calculating line feed error in at least one label having an optical feature on a printer is provided.

In an exemplary embodiment, the method (300) comprises the steps of: (310) providing a first sensor and a second sensor on a holder assembly with a fixed distance, L, between the first sensor and the second sensor; (320) feeding the label over or near the first and second sensors on the holder assembly; (330) sensing a position of the optical feature of the label, L1A, by the first sensor as the label moves over or near the first sensor; (340) sensing a second position of the optical feature label, L1B, by the second sensor as the label moves over or near the second sensor; (350) calculating the distance, L1AB, between the first position and the second position; (360) calculating the line feed error over the fixed distance, L, by taking the difference (L−L1AB); and (370) calculating the feed correction to be done to the label, where the feed correction is given by [(L−L1AB)/L]×D, where D is a distance between the first sensor and the burn line of the printer.

In another exemplary embodiment, the method (300) may further comprise the step of (280) correcting the line feed based upon the step (270) of calculating the feed correction.

In another exemplary embodiment, the method (300) includes the step of (390) repeating steps (310-380) for every label fed over or near the first and second sensors.

In the method (300), the optical feature is a differential opacity of media between an edge of the label and a carrier media. Thus, the sensors are sensing either the position of leading edge of each label, or sensing the trailing edge of each label.

In another exemplary embodiment of the method (300) the optical feature is a fluorescent stripe. The fluorescent stripe is disposed at a predetermined position on each label, and at the same predetermined position on every label fed over or near the first and second sensors.

In any of the embodiments of the method (300) described hereinbefore, the fixed distance L has a tolerance of about +/−20 microns.

In any of the embodiments of the method (300) described hereinbefore, the at least one label is every label fed over or near the first and second sensors.

In any of the embodiments of the method (300) described hereinbefore, the calculating steps (350-370) are preferably accomplished by the printer's processor.

To supplement the present disclosure, this application incorporates entirely by reference the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D733,112;
U.S. Design Pat. No. D734,339;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0342717;
U.S. Patent Application Publication No. 2014/0001267;
U.S. Patent Application Publication No. 2014/0008439;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0078341;
U.S. Patent Application Publication No. 2014/0078345;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166755;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0175172;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0217180;
U.S. Patent Application Publication No. 2014/0231500;
U.S. Patent Application Publication No. 2014/0232930;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0267609;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0278391;
U.S. Patent Application Publication No. 2014/0282210;
U.S. Patent Application Publication No. 2014/0284384;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0312121;
U.S. Patent Application Publication No. 2014/0319220;
U.S. Patent Application Publication No. 2014/0319221;
U.S. Patent Application Publication No. 2014/0326787;
U.S. Patent Application Publication No. 2014/0332590;
U.S. Patent Application Publication No. 2014/0344943;
U.S. Patent Application Publication No. 2014/0346233;
U.S. Patent Application Publication No. 2014/0351317;
U.S. Patent Application Publication No. 2014/0353373;
U.S. Patent Application Publication No. 2014/0361073;
U.S. Patent Application Publication No. 2014/0361082;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0003673;
U.S. Patent Application Publication No. 2015/0009338;
U.S. Patent Application Publication No. 2015/0009610;
U.S. Patent Application Publication No. 2015/0014416;
U.S. Patent Application Publication No. 2015/0021397;
U.S. Patent Application Publication No. 2015/0028102;
U.S. Patent Application Publication No. 2015/0028103;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0048168;
U.S. Patent Application Publication No. 2015/0049347;
U.S. Patent Application Publication No. 2015/0051992;
U.S. Patent Application Publication No. 2015/0053766;
U.S. Patent Application Publication No. 2015/0053768;
U.S. Patent Application Publication No. 2015/0053769;
U.S. Patent Application Publication No. 2015/0060544;
U.S. Patent Application Publication No. 2015/0062366;
U.S. Patent Application Publication No. 2015/0063215;
U.S. Patent Application Publication No. 2015/0063676;
U.S. Patent Application Publication No. 2015/0069130;
U.S. Patent Application Publication No. 2015/0071819;
U.S. Patent Application Publication No. 2015/0083800;
U.S. Patent Application Publication No. 2015/0086114;
U.S. Patent Application Publication No. 2015/0088522;
U.S. Patent Application Publication No. 2015/0096872;
U.S. Patent Application Publication No. 2015/0099557;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0129659;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0136854;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0144701;
U.S. Patent Application Publication No. 2015/0149946;
U.S. Patent Application Publication No. 2015/0161429;
U.S. Patent Application Publication No. 2015/0169925;
U.S. Patent Application Publication No. 2015/0169929;
U.S. Patent Application Publication No. 2015/0178523;
U.S. Patent Application Publication No. 2015/0178534;
U.S. Patent Application Publication No. 2015/0178535;
U.S. Patent Application Publication No. 2015/0178536;
U.S. Patent Application Publication No. 2015/0178537;
U.S. Patent Application Publication No. 2015/0181093;
U.S. Patent Application Publication No. 2015/0181109;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);
U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);
U.S. patent application Ser. No. 14/529,563 for ADAPTABLE INTERFACE FOR A MOBILE COMPUTING DEVICE filed Oct. 31, 2014 (Schoon et al.);
U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. patent application Ser. No. 14/580,262 for MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757 for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER′S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);
U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed Apr. 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application Ser. No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser. No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGUMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER′S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A method of calculating line feed error on a printer comprising the steps of:
a) providing a first sensor and a second sensor under a feed line, wherein the first sensor and the second sensor are separated by a fixed distance;
b) sensing a first position of a first optical feature of a label by the first sensor as the label moves near the first sensor;
c) sensing a second position of the first optical feature of the label by the second sensor as the label moves near the second sensor;
d) calculating a deviation between the fixed distance and distance between the first position and the second position calculation;
e) calculating a ratio of the calculated deviation with respect to the fixed distance; and
f) calculating a feed correction by applying the ratio to a distance value, wherein the distance value is a distance between the first sensor and a burn line of the printer.

2. The method of claim 1, comprising the step of g) correcting the line feed based upon the step f) of calculating the feed correction.

3. The method of claim 2, wherein the calculating steps d-f and the correcting step are accomplished with a processor.

4. The method of claim 1, wherein the fixed distance has a tolerance of about +/−20 microns.

5. The method of claim 1, wherein the first optical feature is defined as a change in the opacity between label and edge.

6. The method of claim 1, wherein the first optical feature is a fluorescent stripe, the fluorescent stripe being disposed at a predetermined position on the label and at the same predetermined position on every label fed near the first and second sensors.

7. The method of claim 1, wherein the deviation is defined as the difference between the fixed distance and the distance between the first position and the second position calculation.

8. A system to calculate line feed error on a printer, comprising:
a first sensor and a second sensor separated by a fixed distance;
a processor communicatively linked to the first sensor and the second sensor;
the first sensor being configured to sense a first position of a first optical feature of a label as the label moves over the first sensor;
the second sensor being configured to sense a second position of the first optical feature of the label as the label moves over the second sensor;
the processor being configured to calculate a distance between the first position and the second position; and
the processor being further configured to calculate a line feed error over the fixed distance by subtracting the calculated distance from the fixed distance.

9. The system of claim 8, wherein the processor is configured to calculate a feed correction to be done to the label by dividing the calculated line feed error over the fixed distance by the fixed distance and multiplying the quotient by a distance between the first sensor and a printer burn line.

10. The system of claim 8, wherein the first optical feature is defined as a change in the opacity between label and edge.

11. The system of claim 10, wherein the first optical feature is at least one of a differential in transmissivity of the media or a differential in reflectance of the media.

12. The system of claim 8, wherein the fixed distance has a tolerance of about +/−20 microns.

13. The system of claim 8, wherein the first optical feature of the label is selected from the leading edge of the label and the trailing edge of the label.

14. A method of calculating line feed error on a printer comprising:
sensing, with a first sensor, a first position of an optical feature of a label as the label moves in a feed line;
sensing, with a second sensor, a second position of the optical feature of the label as the label moves in the feed line, wherein the first sensor and the second sensor are separated by a fixed distance;
calculating a distance between the first position and the second position; and
calculating a line feed error by subtracting the calculated distance from the fixed distance.

15. The method of claim 14, comprising calculating a feed correction by dividing the calculated line feed error by the fixed distance and multiplying the quotient by a distance between the first sensor and a printer burn line.

16. The method of claim 14, wherein the optical feature is at least one of a differential transmissivity or a differential in reflectance between an edge of the label and a carrier media.

17. The method of claim 15, comprising correcting the line feed based on the calculated feed correction.

18. The method of claim 14, wherein the fixed distance has a tolerance of about +/−20 microns.

19. The method of claim 14, wherein the optical feature of the label is selected from the leading edge and the trailing edge of the label.

20. The method of claim 13, wherein the optical feature is a fluorescent stripe.
